(19) United States
(12) Patent Application Publication
(10) Pub. No.: US 2012/0056805 A1
(43) Pub. Date: Mar. 8, 2012

(54) HAND MOUNTABLE CURSOR CONTROL AND INPUT DEVICE

(75) Inventors: Dennis M. Bronner, SR., Birch Run, MI (US); Craig L. Stephenson, Flushing, MI (US)

(73) Assignee: Intellectual Properties International, LLC, Flint, MI (US)

(21) Appl. No.: 12/875,216

(22) Filed: Sep. 3, 2010

(51) Int. Cl. G09G 5/08

(52) U.S. Cl. 345/157

(57) ABSTRACT

A hand wearable cursor control and input device for a computer or other electronic device. The cursor control and input device includes a plurality of interconnected finger fittings. Each finger fitting is configured to receive therein at least the tip of one finger of the user's hand. There are at least three finger fittings of which a first fitting includes a first contact, a second fitting includes a second contact, and third fitting includes a third contact. Engagement of the first contact with the third contact generates a first signal, a first click signal, and engagement of the second contact with the third contact generates a second signal, a second click signal. One of the contacts, such as the third contact, is a touchpad sensor configured to correlate the motion and position of a user's finger being drawn across the surface of the third contact, a movement signal, into relative position of a cursor or pointer on a display screen of the computer or other electronic device. Additionally, there may include a fourth finger fitting having a fourth contact, which when engaged with the third contact, causes operation of the third contact as a touchpad and initiates the movement signal.

### BACKGROUND

1. Field of the Invention

The present invention generally relates to the field of peripheral input devices for electronic devices, including devices such as general and personal computers. More specifically, the invention relates to a device that controls positional movement of a cursor on a video display and the various “click” controls that implement the “select” function, the “drag” function, and various other functions associated with mouse-type devices.

2. Description of Related Art

Computers and other electronic devices are widely used throughout the world on an everyday basis. These devices have found themselves being used, not only in the business world and government environments, but also in schools, homes, and more recently in public places such as coffee shops, airports and public parks. Conventionally, computers and other electronic devices with a display screen are operated using a keyboard and a mouse. The keyboard is used to enter text and commands. The mouse is typically used to control the location and movement of a cursor on the display screen and is used for inputting various commands into the computer or electronic device. The mouse typically includes a tracking device for measuring the movement of the mouse across the surface supporting the mouse. This movement is relayed to the computer or electronic device, where it is translated into a corresponding movement of the cursor on the display screen. These tracking devices are often roller balls or optical, such as laser, devices and are well known and widely implemented. The mouse is connected to the computer or electronic device by way of a cable and a connector, such as a USB connector, or communicate wirelessly via infrared or radio frequencies. In addition to the tracking device, the mouse typically includes buttons that operate as switches to initiate a function or command identified by the location of the cursor. By clicking the button, the command is initiated. Alternatively, the buttons can be configured to operate various features of the software running on the computer or electronic device. There are many possible such features and representative ones include the highlighting of text in a word processing program or the displaying of a menu of commands and the selecting of a command therefrom.

A conventional mouse of the above described variety has several drawbacks. One particular drawback arises in connection with use of the mouse with a keyboard. When used in conjunction with a keyboard, in order to control movement of the cursor on the display screen and to select various software commands displayed on the screen, the user must remove their hand from the keyboard and then reach for and grasp the mouse. Thus, the person using the keyboard and mouse must frequently move their hand between the keyboard and the mouse. Depending on the activity, this can be infrequent or constant. Obviously, this can be both cumbersome and time consuming.

In view of the above, it is apparent that there exists a need for a more efficient cursor control and input device, one that would improve the productivity and performance of the person using the device.

### SUMMARY

In overcoming the above and other drawbacks of the know technology, the present invention provides a peripheral input device that is intended to be worn on a user's hand, similarly to a glove. The glove includes fittings for various fingers and sensor/contacts are provided in the fittings. By manipulation of the user's fingers, bringing various fittings into engagement with one another, and therefore various sensors and contacts into close proximity with one another, the user is able to perform the various operations tasks associated with a computer mouse.

Accordingly, in one aspect the present invention is a hand wearable cursor control and input device for a computer or other electronic device. The cursor control and input device includes a glove having interconnected finger fittings. Each finger fitting is configured to receive therein at least the tip of one finger of the user's hand. There are at least three finger fittings of which a first fitting includes a first contact, a second fitting includes a second contact, and third fitting includes a third contact. Engagement of the first contact with the third contact generates a first signal and engagement of the second contact with the third contact generates a second signal. One of the contacts, such as the third contact, is a touchpad sensor configured to translate the motion and position of a user's finger being drawn across the surface of the third contact into relative position of a cursor or pointer on a display screen of the computer or other electronic device.

In another aspect of the invention, the cursor control and input device further includes a communication means for connecting the cursor control and input device to the computer or other electronic device. In one embodiment the communication mean is a wired connection including a cable and a plug. In another embodiment the communication means is a wireless connection including a transmitter, such as a radio frequency transmitter or an infrared transmitter.

In further aspect of the invention, the touchpad is a capacitance touchpad or a conductance touchpad.

In still another aspect of the invention, the touchpad is flexible.

In yet another aspect, the touch pad includes defined areas for contact with the first and second contacts.

In another aspect of the invention, the first and second contacts are non-pressure sensitive contacts.

In a further aspect of the invention, the electronic device is a computer.

In still another aspect of the invention, the cursor control and input device includes a fourth fitting of the finger fittings; the fourth fitting including a fourth contact wherein engagement of the fourth contact with the third contact generates a movement signal thereby operating the third contact as a touchpad.

In yet another aspect of the invention, the engagement of either of the first contact or the second contact with the third contact generates a click signal and thereby does not operate the third contact as a touchpad.

In another aspect of the invention, the third contact includes a circuit forming portion and touchpad portion.

In a further aspect of the invention, the circuit forming portion and touchpad portion are spaced apart from one another.

In a still further aspect of the invention, the circuit forming portion and the touchpad portion are contiguous with one another.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a plan view of a peripheral input device embodying the principals of the present invention and seen on one hand of a user, when viewed looking toward the palm of the user's hand;

FIG. 2 is a plan view of the peripheral input device seen in FIG. 1 as viewed from the back of the user's hand;

FIG. 3 is a side perspective view of the peripheral input device embodying the principals of the present invention;

FIG. 4 is a perspective side view illustrating one operational position of the peripheral input device seen in FIG. 1;

FIG. 5 is a side perspective view of a second operational position of the peripheral input device;

FIG. 6 is a perspective view of a third operational position of the peripheral input device;

FIG. 7 is a plan view of a second embodiment of a peripheral input device according to the principals of the present invention and illustrated as worn on the hand of a user and viewed from the back side of the user's hand; and

FIG. 8 is a side perspective view of a first operational position of the peripheral input device seen in FIG. 7.

### DETAILED DESCRIPTION

Referring now to the drawings, a peripheral input device embodying the principles of the present invention is illustrated therein and generally designated at 10. As seen therein, the peripheral input device 10 is generally in the form of a glove and is worn on a user's hand 18. While the peripheral input device, herein after “glove 10”, is shown as being worn on a right hand, it will be appreciated that the principles embodied by the glove 10 are readily adaptable for implementation in a left handed glove.

As its primary components, the glove 10 has four finger sleeves or fittings 14 that are connected to each other by a backing or webbing 16 and retained on the person's hand 18 by a wrist strap 20. The backing 16 is connected to each of the finger fittings 14 and as such includes a central portion 22 and a plurality of extensions 24, the latter of which extend from the central portion 22 and are respectively connected to one of the fittings 14.

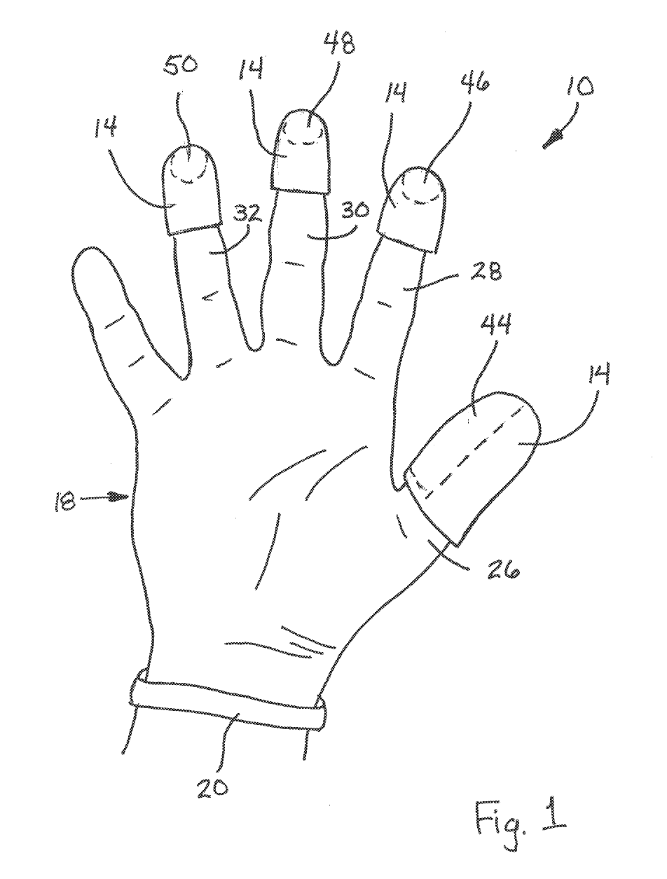

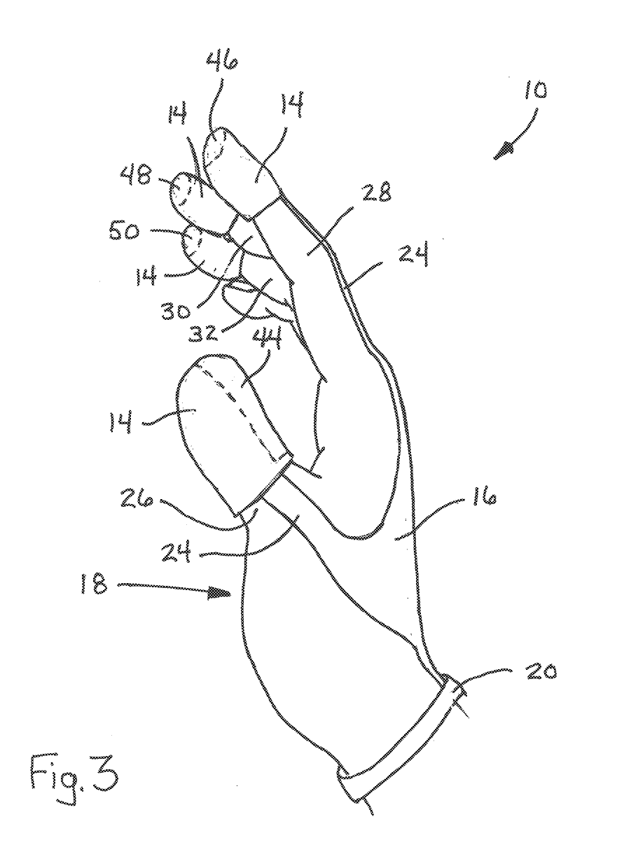

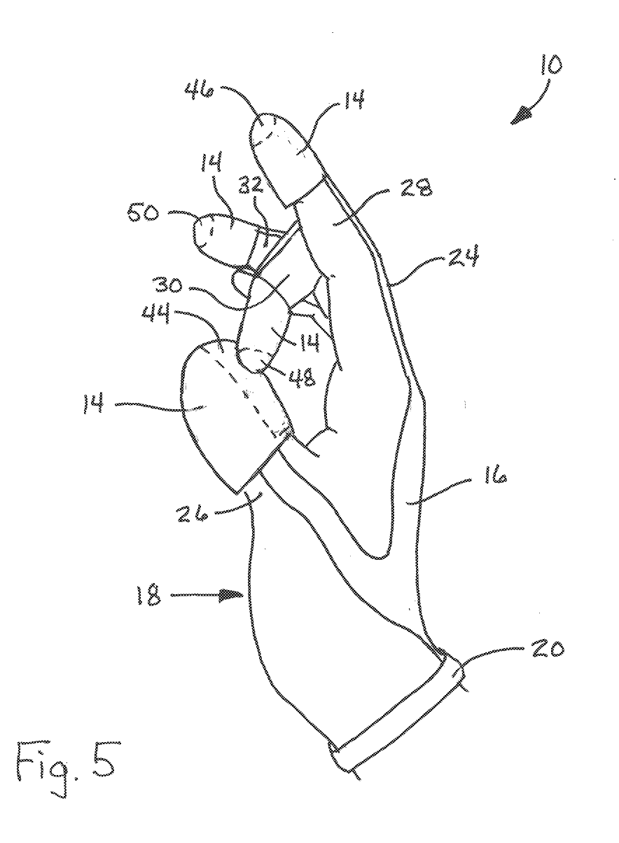

The fittings 14 themselves are generally cup or thimble-shaped and define receptacles into which the corresponding fingertips of a person's hand 18 are received. As seen in FIGS. 1-6, in one embodiment the glove 10 has four fittings 14, which include a fitting 14 for each of the thumb 26, index finger 28, middle finger 30 and ring finger 32. The fittings 14 may be made out of a variety of materials including various textiles or fabrics, leather, or plastic. Preferably, the fittings 14 are formed of a durable material having a slight elasticity so as to enable the fittings 14 to conform to the shape of the tips of the fingers 26-32 without adding significant bulk or weight thereto.

The backing 16 may also be formed of a variety of materials, including those previously mentioned. Preferably the backing 16 is resiliently and elastic in nature. In this way, the backing 16 enables the glove 10 to flex and stretch during articulation of one's hand and various fingers while wearing the glove 10. The resiliency and flexibility of the backing 16 should be sufficient so as to allow a user of the glove 10 to type on a keyboard while wearing the glove 10.

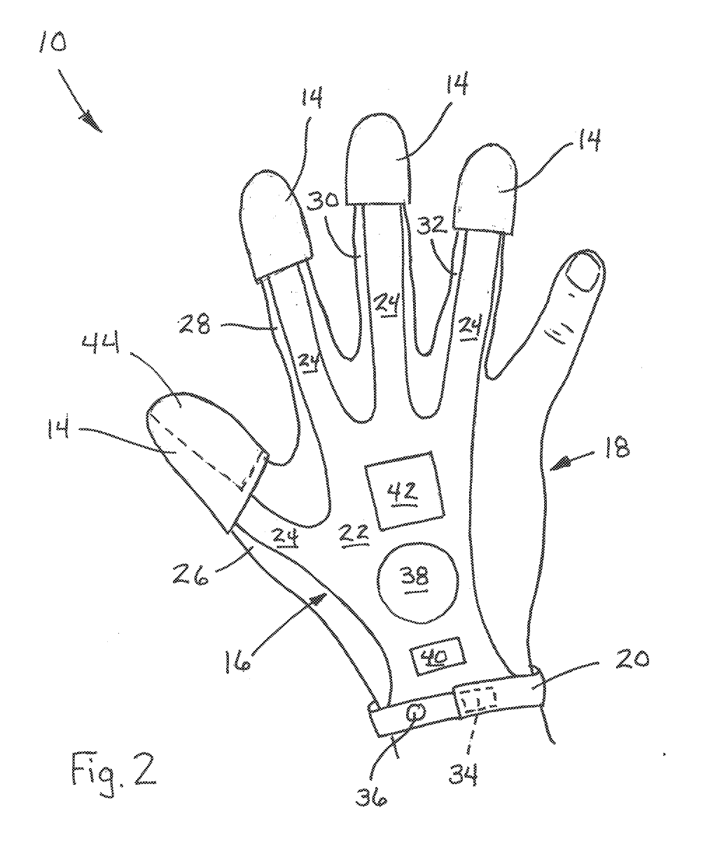

The wrist strap 20 is secured to the central portion 22 of the backing 16, generally opposite from the extensions 24, and extends laterally relative to the central portion 22 of the backing 16, thereby allowing the wrist strap 20 to be wrapped around the wrist of the person's hand 18. The wrist strap 20 includes corresponding parts of a fastener 34 located on generally opposing ends thereon to aid in securing the wrist strap 20 to itself and the glove 10 to the person's hand 18. The fastener 34 may be any one of the number of well known fasteners, including hook and loop fasteners, snap fasteners, buttons or other means for fastening the ends of the wrist strap 20 together. This fasten 34 is generally represented in FIG. 2 as a hook and loop fastener 34.

The glove 10 is intended to provide all of the functional attributes of the conventional peripheral input device known as a mouse and which is used with computers or other electronic devices. (For the sake of brevity and without intending to be limited thereby, where reference in this specification is made to just a computer, the intended reference is not only to a computer, but also to any other electronic device with which the glove 10 may find applicability as in input for controlling movement of an object on a display screen and/or designating commands.)

Preferably, the glove 10 is provided in a wireless form such that the glove 10 is not physically connected to the computer with which it is being used. If provided in a non-wireless form, the glove 10 is connected to the computer by way of a cable and connector (not shown), such as a cable having a USB connector provided on the end thereof. As illustrated in all of the attached drawings, the glove 10 is provided in a wireless form. Being wireless, the glove 10 includes an on/off switch 36 that is connected to a power source, such as a battery 38. When the ON/OFF switch 36 is located in the ON position, various contacts and sensors associated in the finger fittings 14 are enabled to provide signals that are relayed via a transmitter 40 to the computer. The transmitter 40 may communicate with the computer by various known communication techniques, including infrared communication and short range radio frequency communications, such as Bluetooth™ technology. The sensors and contacts of the finger fittings 14 are electrically connected to a printed circuit 42, which is in turn connected to the battery 38, the transmitter 40 and ON/OFF switch 36. The printed circuit 42, which includes the appropriate electronic devices, receives the signals generated by the contacts and sensors and processes the signals such that they may be transmitted by the transmitter 40 to the computer for acting upon thereby. As set forth below, each of the finger fittings include at least one contact or sensor, the operation of which is intended to correspond with at least one functional attribute of a conventional computer mouse.

Provided on the finger fitting 14 of the thumb 26, generally oriented toward the other fittings 14, is a touch pad sensor 44. Preferably, the touch pad sensor 44 is of the well known capacitance sensing variety and is sufficiently flexible so as to conform to the shape of the fitting 14 and not be susceptible to breakage during normal use and handling of the glove 10. Alternatively the touchpad sensor 44 may be of a conductance variety or other variety.

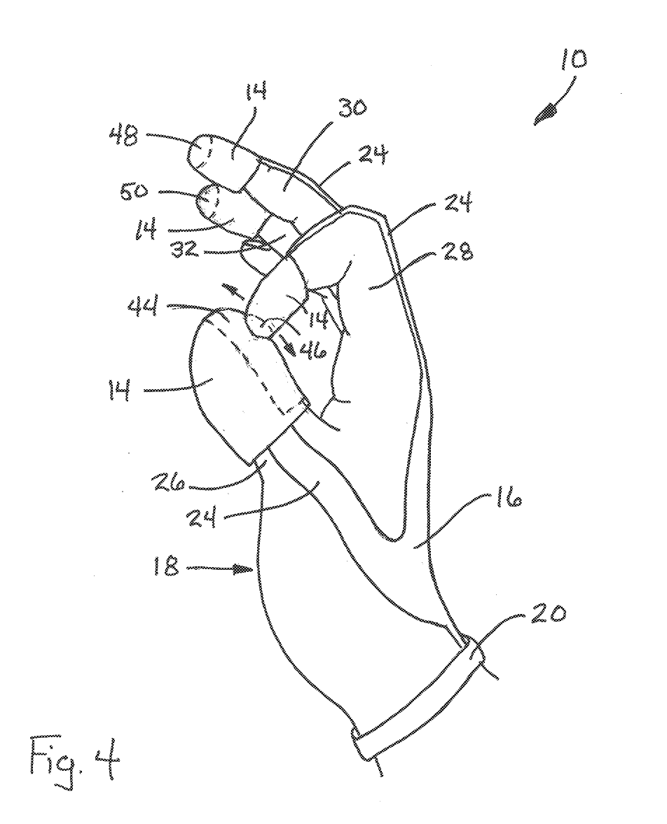

Provided on the finger fitting 14 of the index finger 28 is a contact 46. When the contact 46 is brought into engagement with the touch pad sensor 44, as seen in FIG. 4, a cursor control or “movement” signal is received by the printed circuit 42, process and forwarded via the transmitter 40 to computer associated therewith. The computer translates the signal into movement of a cursor on the display screen of the computer. As the contact 46 is moved across the surface of the touch pad sensor 44, the changing “movement” signal will cause corresponding movement of the cursor on the display screen of the computer. Thus, the cursor is moved in the same manner as it would be moved by a conventional computer mouse when the computer mouse is moved on a mouse pad or other surface. Thus, by moving the finger fitting 14 of the index finger 28 upward along the touch pad sensor 44, generally toward the tip of the thumb 26, the cursor would be caused to move upward on the display screen. Conversely, movement of the finger fitting 14 on the index finger 28 in an opposite direction, downward along the touch pad sensor 44, would cause downward movement of the cursor on the display screen of the computer. Movement to the right or left on the touch pad sensor 44 during engagement of the finger fitting 14 of the thumb 26 will cause corresponding right and left movement of the cursor.

A contact 48 is provided on the finger fitting 14 of the middle finger 30. When the contact 48 associated with the middle finger 30 is brought into engagement with the touch pad sensor 44, the engagement is registered as a signal different from the movement signal when the contact 46 (related to the index finger 28) engages the touch pad sensor 44. This different signal, or reading thereof, is preferably achieved by creating a different capacitance during engagement of the contact 48 with the touch pad sensor 44 or by way of forming a closed circuit during this engagement. As a result, the engagement of the contact 48 with the touch pad sensor 44 is registered as a “click” signal, and more specifically corresponds to a left button click of a computer mouse, instead of movement signal across the surface of the touch pad sensor 44. Thus, if the contact 48 is engaged once with the touch pad sensor 44, it is registered as a single click of the left button on a computer mouse. If the contact 48 is brought into engagement with the touch pad sensor 44 twice in succession, this engagement is registered as a double click of the left button on a computer mouse. The single or double clicks are accordingly processed and subsequently communicated by the transmitter 40 to the computer, which interprets them the selecting of the object then associated with the position of the cursor on the display screen or another command.

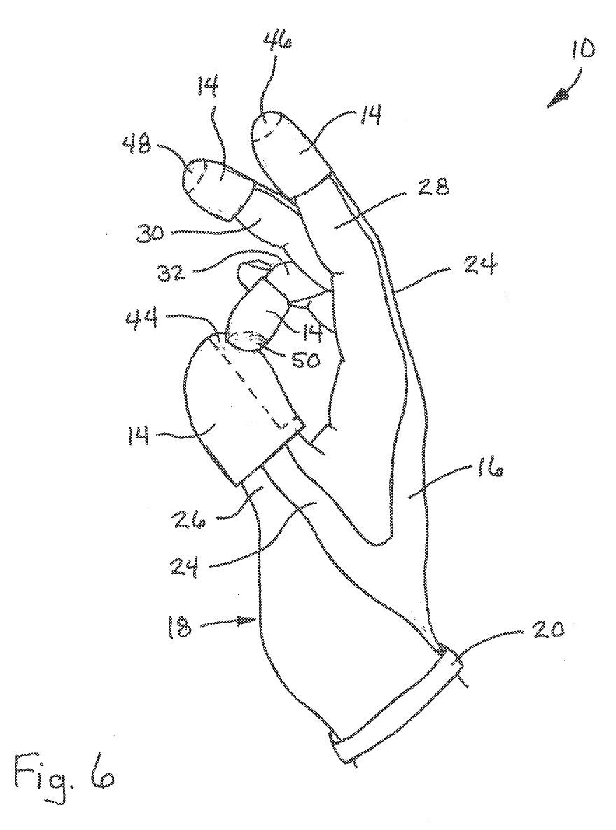

Similarly, a contact 50 is provided on the finger fitting 14 of the ring finger 32 and the contact 50 associated with the ring finger 32 can be brought into engagement with the touch pad sensor 44. This is generally illustrated in FIG. 6. In one aspect, this engagement of the contact 50 with the touch pad 44 is similar to that of contact 48 and its engagement with the touch pad sensor 44. In other words, the engagement of the contact 50 with the touch pad sensor 44 registers as a click signal and not as movement signal associated with movement across surface of the touch pad sensor 44. The engagement of contact 50 with the touch pad sensor 44 corresponds to the clicking of the right button on a computer mouse. If the contact 50 is brought into successive engagement with the touch pad 44, then this engagement is registered as a double click corresponding to the double clicking of the right button on a computer mouse. The respective single or double click signals are likewise processed and communicated to the computer and handled thereby as single or double clicks of the right hand button of a computer mouse.

In order to differentiate between the various engagements of the contacts 46, 48 and 50 with the touch pad sensor 44, it is believed that the contacts 46, 48 and 50 should preferably impart a different capacitance when engaged with the touch pad sensor 44. The different capacitance is then interpreted by the printed circuit and the appropriate signals communicated by the transmitter 40 to the computer. Accordingly, contact of the touch pad sensor 44 with each of the contacts 46, 48 and 50 is differentiable such that different results are achieved with the corresponding computer.

Alternatively, the touch pad sensor 44 can be provided with a delimited area that operates as a contact for closing a circuit with the contacts 48 and 50 and operating analogously to a switch.

Additionally, it should be noted that signals are not generated upon the engagement of the sensor 44 or the contacts 46, 48 and 50 with other surfaces or objects. As such, the contacts 46, 48 and 50 are not pressure or contact switches, and engagement of the contacts 46, 48 and 50 with objects or surfaces other than the touch pad sensor 44 produces no signals or operational functions of the glove 10. Similarly, contact of an object with the sensor 44 is not registered as an intended contact for purposes of operating the glove 10 in a manner corresponding to a computer mouse. This is important because providing the glove 10 is intended to allow is use and wearing by a person as they are typing on a keyboard associated with computer. By not interpreting other engagements with the sensor 44 or with the contacts 46, 48 and 50, typing on the keyboard will not alter the position of the cursor on the display screen of the computer, nor will it cause the selection or initiation of a command.

One benefit of the glove 10 is that in order to move the cursor on the display screen of the computer, the user of computer does not need to remove their hand from the region of the keyboard so as to reach for and grasp a computer mouse. All of the operational functions of the computer mouse can be conducted merely by lifting one's hand off of the keyboard and manipulating the appropriate finger fitting 14 for the intended function. Where a keyboard is not utilized, the glove 10 may be operated without the need for a surface to support and interact with the glove 10. In other words, the glove 10 does not need to be drawn across a surface or used in conjunction with a mouse pad. The glove 10 may be operated in “mid-air.”

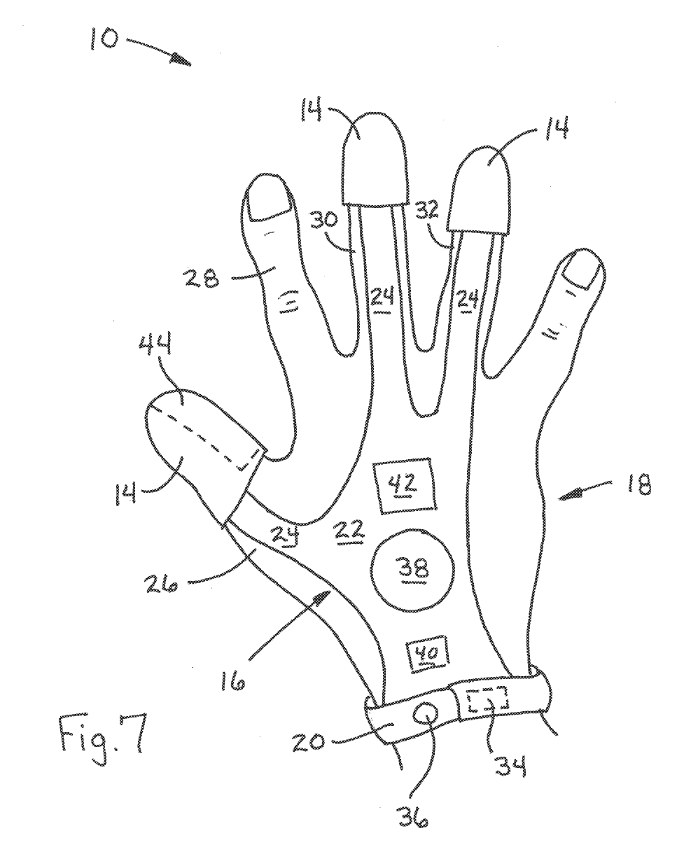

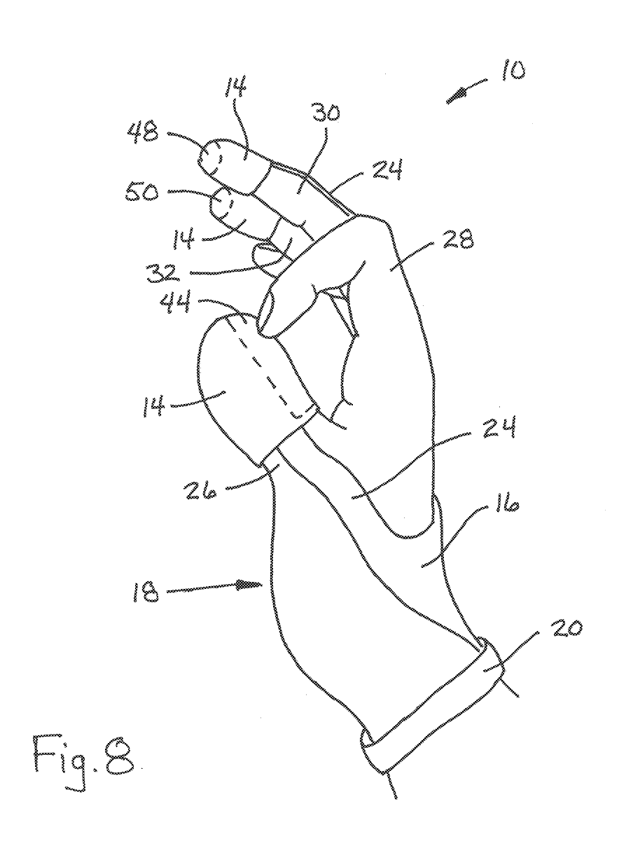

An additional embodiment of the invention is generally illustrated in FIGS. 7 and 8. As seen therein, the glove is substantially identical to that seen in FIGS. 1-6, except that the glove 10 lacks a finger fitting 14 associated with the index finger 28. All other aspects of the glove 10 are the same and identical to that of the prior embodiment and, accordingly, like reference numerals are provided in association therewith.

In this alternative embodiment, the printed circuit 42 is configured to receive a movement signal from the touch pad sensor 44 resulting from a capacitance created by contact of the skin of the index finger 28 with the touch pad sensor 44. By contacting the surface of the index finger 28 with the touch pad sensor 44, as seen in FIG. 8, movement of a cursor on the display screen of a computer can is effectuated. Since further operation of the glove 10 according to this embodiment is identical with that of the prior embodiment, further description in this regard is not set out herein. In this regard, reference is therefore made to the discussion relating to the contacts 48 and 50 and their engagement with the touch pad sensor 44 as previously set out in this specification in connection with the prior embodiment.

While the previously discussed embodiments include a backing 16 that interconnects the fittings 14 with one another, in a further embodiment, it is envisioned that the fittings 14 may be provide individually and not be interconnected by a backing. In such a construction, the plurality of fittings 14 may be physically disconnected from each other and carry the needed circuitry to enable wireless operation of their respective sensors. Alternatively, the fittings 14 may be interconnected to one another by a means other than the backing, namely interconnected only by wired connections.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I/We claim:

1. A hand wearable cursor control and input device for a computer or other electronic device, the cursor control and input device comprising:
a plurality of finger fittings, each finger fitting configured to be received onto a tip of a different finger of a user's hand;
a first fitting of said finger fittings having a first contact;
a second fitting of said finger fittings having a second contact;
a third fitting of said finger fittings having a third contact;
wherein engagement of the first contact with the third contact generates a first signal;
wherein engagement of the second contact with the third contact generates a second signal; and
wherein the third contact is a touchpad sensor configured to translate motion and position of a user's finger drawn across the third contact to a relative position of a cursor or pointer on a display screen of the computer or other electronic device.

2. The cursor control and input device of claim 1 further comprising communication means for connecting the cursor control and input device to the computer or other electronic device.

3. The cursor control and input device of claim 2 wherein the communication mean is a wired connection including a cable and a plug.

4. The cursor control and input device of claim 2 wherein the communication means is a wireless connection including a transmitter.

5. The cursor control and input device of claim 4 wherein the transmitter is a radio frequency transmitter.

6. The cursor control and input device of claim 4 wherein the transmitter is an infrared transmitter.

7. The cursor control and input device of claim 1 wherein the touchpad is a capacitance touchpad.

8. The cursor control and input device of claim 1 wherein the touchpad is a conductance touchpad.

9. The cursor control and input device of claim 1 wherein the touchpad is flexible.

10. The cursor control and input device of claim 1 wherein the touchpad includes one or more defined areas for contact with the first and second contacts.

11. The cursor control and input device of claim 1 wherein the first and second contacts are non-pressure sensitive contacts.

12. The cursor control and input device of claim 1 wherein the electronic device is a computer.

13. The cursor control and input device of claim 1 further comprising a fourth fitting of said finger fittings, the fourth fitting including a fourth contact, wherein engagement of the fourth contact with the third contact generates a movement signal thereby operating the third contact as a touchpad.

14. The cursor control and input device of claim 1 wherein engagement of either of the first contact or the second contact with the third contact generates a click signal and thereby does not operate the third contact as a touchpad.

15. The cursor control and input device of claim 1 wherein the third contact includes a circuit forming portion and touchpad portion.

16. The cursor control and input device of claim 1 wherein the circuit forming portion and touchpad portion are spaced apart from one another

17. The cursor control and input device of claim 1 wherein the circuit forming portion and the touchpad portion are contiguous with one another.

18. The cursor control and input device of claim 1 wherein the plurality of finger fittings is interconnected with one another.

19. The cursor control and input device of claim 18 wherein the plurality of finger fittings is interconnected with one another by a backing and generally form a glove.
